(19) United States
(12) Patent Application Publication
(10) Pub. No.: US 2009/0132429 A1
(43) Pub. Date: May 21, 2009

(54) Programmable Financial Instruments

(76) Inventor: Marc Michael Groz, Stamford, CT (US)

Correspondence Address: MARK S. NOWOTARSKI, 30 GLEN TERRACE, STAMFORD, CT, 06906, US

(21) Appl. No.: 11/382,083

(22) PCT Filed: Dec. 8, 2004
(86) PCT No.: PCT/US04/41176

§ 371 Date: May 8, 2006

Related U.S. Application Data
(63) Continuation-in-part of application No. 10/733,482, filed on Dec. 11, 2003, now abandoned.
(60) Provisional application No. 60/432,851, filed on Dec. 12, 2002.

(51) Int. Cl. G06Q 40/00

(52) U.S. Cl. 705/36 R

(57) ABSTRACT

A method and system is disclosed for creating and using programmable financial instruments. The method and system addresses the problems caused by limiting the scope of financial instruments to inert objects, whether considered as abstract data or in a physical embodiment such as a paper certificate. Applications of the method and system include trading, portfolio management, collateralization, securitization, securities lending, securities borrowing, and credit enhancement.

### CROSS REFERENCE TO RELATED APPLICATION

This application is a continuation in part and claims benefit of U.S. Nonprovisional patent application Ser. No. 10/733,482, entitled “Programmable Financial Instruments”, filed Dec. 11, 2003, which is hereby incorporated by reference.

U.S. Nonprovisional patent application Ser. No. 10/733,482, in turn, claims benefit of U.S. Provisional Application 60/432,851 filed Dec. 12, 2002 and which is hereby incorporated by reference.

### TECHNICAL FIELD

This is invention is in the field of computer implemented financial instruments.

### BACKGROUND ART

Historically, financial instruments have been associated with pieces of paper or other tangible tokens of their existence, ownership, and other terms and conditions. Sometimes financial instruments are represented by said tangible tokens; in other instances, the financial instruments are embodied by (or identified with) said tangible tokens.

With the development of sophisticated computer and communications technology, the concept of financial instrument has migrated (along with much else) into the virtual world of digital data. While this migration has (in the parlance of Wall Street) “dematerialized” stock certificates, it has not altered their status as objects. Securities (and other financial instruments) are represented or embodied by things that are moved about by people and their agents. More and more often, the agents are computer programs and the representations/embodiments are bits of data. The result has been a great increase in the speed, distance, and volume of transactions.

We shall refer to financial instruments that may be represented (or embodied) by paper or bits of data as data-based financial instruments (DFIs). DFIs are enormously useful, enabling global commerce and facilitating wealth creation. Nonetheless, commerce is not always best facilitated by DFIs.

There are several contexts in which it would be useful to have a different type of financial instrument that extends the concept of financial instrument beyond representation/embodiment as data to representation/embodiment as program. As explained in the sections that follow, these contexts include:
Securities Trading
Portfolio Management
Collateral Management
Securitization
Securities Lending
Risk Management
Credit Enhancement
General Commerce

### DISCLOSURE OF THE INVENTION

We may define a “programmable financial instrument” (“PFI”) as a financial instrument represented (or embodied) by an active software/system component or module which may be linked to one or more physical devices. Said component or module may reside or otherwise be associated with computer and related hardware which may include (without limitation) electronic computers, optical computers, biological computers, or quantum computers capable of operating with qubits and entangled states.

A PFI may be represented abstractly as
P(x₁, . . . , xₙ), where x₁, . . . , xₙ are inputs and/or state variables of program P.

In a preferred embodiment, a PFI may be implemented as an internet/web agent, i.e., as a persistent, active software/system component with the capacity to communicate, perceive, reason, and act within its environment. The environment of said PFI may include one or more computer and/or communications networks including public networks, private networks, and the Internet. Said environment may also include the physical environment of one or more physical devices to which said PFI may be linked. Said PFI may interact with other internet/web agents and with other physical devices.

In an alternative preferred embodiment, a PFI may be implemented as a physical device subject to influence by an active software/system component or module and the physical environment. Said PFI may interact with other physical devices and preferably with internet/web agents.

### BRIEF DESCRIPTION OF DRAWINGS

The above summary of the invention will be better understood when taken in conjunction with the following detailed description and accompanying drawings in which:

FIG. 1 is a flow chart of a preferred embodiment of the operation and use of the invention for trading and portfolio management;

FIG. 2 is a flow chart of a preferred embodiment of the operation and use of the invention for auto-collateralization;

FIG. 3 is a flow chart of a preferred embodiment of the operation and use of the invention for auto-securitization;

FIG. 4 is a flow chart of a preferred embodiment of the operation and use of the invention for auto-securities-lending;

FIG. 5 is a flow chart of a preferred embodiment of the operation and use of the invention for auto-securities-borrowing;

FIG. 6 is a flow chart of a preferred embodiment of the operation and use of the invention for auto-credit-enhancement.

### MODES FOR CARRYING OUT INVENTION

Financial markets are constantly striving to reduce the costs and complexity of their operations. One constraint on financial market efficiency stems from the nature of all existing financial instruments. They are inert objects, and do not exhibit adaptive behavior. Recent innovations in financial engineering have led to objects whose valuation can be a matter of considerable complexity (“exotic derivatives”). Nevertheless, even said exotic derivatives are inert. They cannot trade with other derivatives, nor can they perform valuation, risk management, or regulatory functions. If derivatives (and other financial instruments) can be made smarter, financial markets will become fairer, safer, and more efficient.

A method and system is disclosed for creating and using programmable financial instruments. The method and system addresses the problems caused by limiting the scope of financial instruments to inert objects, whether considered as abstract data or in a physical embodiment such as a paper certificate. Applications of the method and system include trading, portfolio management, collateralization, securitization, securities lending, securities borrowing, and credit enhancement.

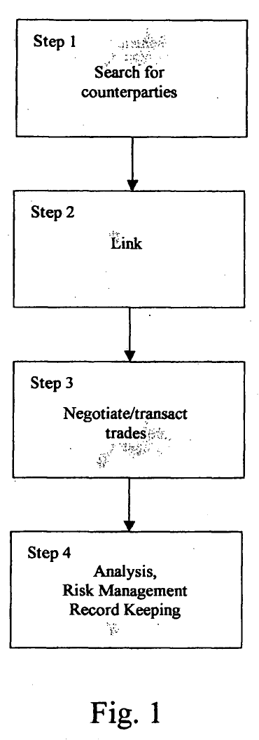

A preferred embodiment for operation and use of the invention for trading and portfolio management is now described in connection with FIG. 1.

As shown in FIG. 1, step 1, PFIs which may preferably be programmable internet/web agents (preferably linked to physical devices) scour one or more computer networks (and preferably other virtual environments and/or physical environments) for counterparties. In step 2, said PFIs may link up with one or more other PFIs to create one or more pools of PFIs (“PPFI”). In step 3, said PFIs and/or PPFIs may negotiate with other web agents (and preferably virtual and/or physical devices) to trade one or more PFIs and/or DFIs. In step 4, said PFIs may preferably perform market analysis, risk management, and/or record-keeping functions and/or communicate transactional and/or other information to other agents or facilities. Transactions may result in changes to the internal state of one or more said PFIs or to changes in the ownership and/or custody arrangements of one or more PFIs and/or DFIs. Other web agents (and preferably virtual and/or physical devices) representing and/or embodying actual or potential buyers, sellers, or third parties such as regulators and/or service providers, may negotiate and transact with said PFIs and/or PPFIs.

In an alternative preferred embodiment for operation and use of the invention for trading and portfolio management, PFIs may be physical devices subject to influence by an active software/system component or module and the physical environment. Said PFIs may scour said environment (and preferably computer/communications networks) for counterparty physical devices (and preferably web agents). Said PFIs may link up with other PFIs to create one or more pools of PFIs (“PPFI”). Said PFIs and/or PPFIs may negotiate with other physical devices (and preferably web agents) to trade one or more PFIs or DFIs. Said PFIs may preferably perform market analysis, risk management, and/or record-keeping functions and/or communicate transactional and/or other information to other agents or facilities. Transactions may result in changes to the internal state of one or more said PFIs or to changes in the ownership and/or custody arrangements of one or more DFIs. Other physical devices (and preferably web agents), representing actual or potential buyers, sellers, or third parties such as regulators and/or service providers, may negotiate and transact with said PFIs and/or PPFIs.

[Note: Both of the above-described preferred embodiments create PFIs that may assemble themselves into portfolios on behalf of their owners, fiduciaries, or agents thereof, allowing the PFIs to help manage portfolios, trade, analyze markets, manage risk, keep records-subject to constraints imposed by the program, other agents, and the environment. The inclusion of physical devices allows human traders, analysts, risk managers, portfolio managers, and others to enter and interact in this environment with human and computer counterparts all over the world—both in physical and virtual space.]

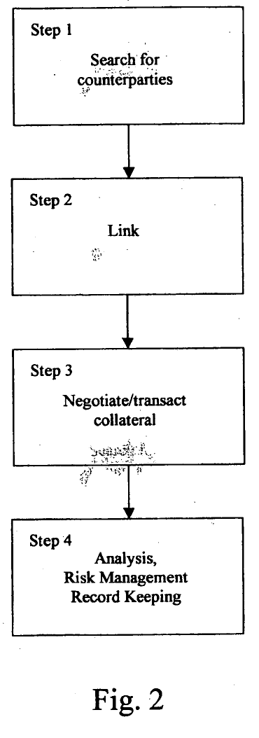

A preferred embodiment for operation and use of the invention for auto-collateralization is now described in connection with FIG. 2.

As shown in FIG. 2, step 1, PFIs which may preferably be programmable internet/web agents (preferably linked to physical devices) scour one or more computer networks (and preferably other virtual environments and/or physical environments) for counterparties. In step 2, said PFIs may link up with one or more other PFIs to create one or more pools of PFIs (“PPFI”). In step 3, said PFIs and/or PPFIs may negotiate with other web agents (and preferably virtual and/or physical devices) to form one or more new PFIs and/or DFIs collateralized by said PFIs, PPFIs, and/or DFIs. In step 4, said PFIs may preferably perform market analysis, risk management, and/or record-keeping functions and/or communicate transactional and/or other information to other agents or facilities. Transactions may result in changes to the internal state of one or more said PFIs or to changes in the ownership and/or custody arrangements of one or more PFIs and/or DFIs. Other web agents (and preferably virtual and/or physical devices) representing and/or embodying actual or potential buyers, sellers, or third parties such as regulators and/or service providers, may negotiate and transact with said PFIs and/or PPFIs.

In an alternative preferred embodiment, PFIs may be physical devices subject to influence by an active software/system component or module and the physical environment. Said PFIs may scour said environment (and preferably computer/communications networks) for counterparty devices (and preferably web agents). Said PFIs may link up with other PFIs to create one or more pools of PFIs (“PPFI”). Said PFIs and/or PPFIs may negotiate with other physical devices (and preferably web agents) to form one or more new PFIs collateralized by said PFIs and/or PPFIs. Other physical devices (and preferably web agents), representing actual or potential buyers, sellers, or third parties such as regulators and/or service providers, may negotiate and transact with said PFIs and/or PPFIs.

[Note: Both of the above-described preferred embodiments create PFIs that may assemble themselves into portfolios on behalf of their owners, fiduciaries, or agents thereof, allowing the PFIs to help manage collateralized portfolios, trade, analyze markets, manage risk, keep records—subject to constraints imposed by the program, other agents, and the environment. The inclusion of physical devices allows human traders, analysts, risk managers, portfolio managers, and others to enter and interact in this environment with human and computer counterparts all over the world—both in physical and virtual space.]

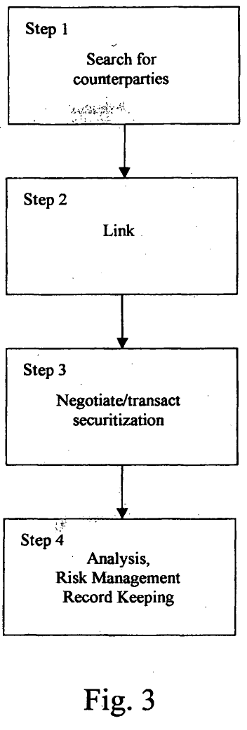

A preferred embodiment for operation and use of the invention for auto-securitization is now described in connection with FIG. 3.

As shown in FIG. 3, step 1, PFIs which may preferably be programmable internet/web agents (preferably linked to physical devices) scour one or more computer networks (and preferably other virtual environments and/or physical environments) for counterparties. In step 2, said PFIs may link up with other PFIs to create one or more asset pools of PFIs (“APFI”). In step 3, said PFIs and/or APFIs may negotiate with other web agents (and preferably virtual and/or physical devices) to form one or more new PFIs, APFIs, and/or DFIs securitized by said PFIs and/or APFIs. Other web agents (and preferably physical devices) representing actual or potential buyers, sellers, or third parties such as regulators and/or service providers, may negotiate and transact with said PFIs and/or APFIs. In step 4, said PFIs may preferably perform market analysis, risk management, and/or record-keeping functions and/or communicate transactional and/or other information to other agents or facilities. Transactions may result in changes to the internal state of one or more said PFIs or to changes in the ownership and/or custody arrangements of one or more PFIs and/or DFIs. Other web agents (and preferably virtual and/or physical devices) representing and/or embodying actual or potential buyers, sellers, or third parties such as regulators and/or service providers, may negotiate and transact with said PFIs and/or PPFIs.

In an alternative preferred embodiment, PFIs may be physical devices subject to influence by an active software/system component or module and the physical environment. Said PFIs may link up with other PFIs to create one or more asset pools of PFIs (“APFI”). Said PFIs and/or APFIs may negotiate with other web agents (and preferably physical devices) to form one or more new PFIs securitized by said PFIs and/or APFIs. Other web agents (and preferably physical devices) representing actual or potential buyers, sellers, or third parties such as regulators and/or service providers, may negotiate and transact with said PFIs and/or APFIs.

[Note: Both of the above-described preferred embodiments create PFIs that may assemble themselves into portfolios on behalf of their owners, fiduciaries, or agents thereof, allowing the PFIs to help manage securitized portfolios, trade, analyze markets, manage risk, keep records—subject to constraints imposed by the program, other agents, and the environment. The inclusion of physical devices allows human traders, analysts, risk managers, portfolio managers, and others to enter and interact in this environment with human and computer counterparts all over the world—both in physical and virtual space.]

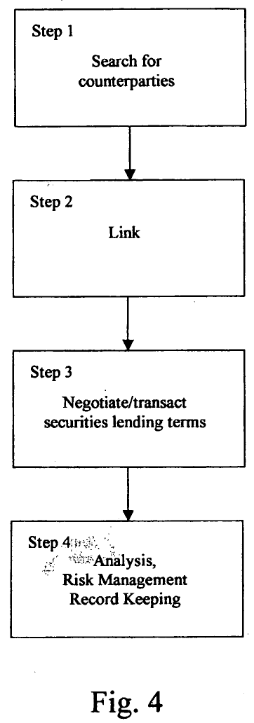

A preferred embodiment for operation and use of the invention for auto-securities lending is now described in connection with FIG. 4.

As shown in FIG. 4, step 1, PFIs which may preferably be programmable internet/web agents (preferably linked to physical devices) scour one or more computer networks (and preferably other virtual environments and/or physical environments) for counterparties. In step 2, said PFIs may link up with other PFIs to create one or more lending pools of PFIs (“LPFI”). In step 3, said PFIs and/or LPFIs may negotiate with other web agents (and preferably virtual and/or physical devices) to form one or more new PFIs, LPFIs, and/or DFIs securitized by said PFIs and/or LPFIs. Other web agents (and preferably physical devices) representing actual or potential borrowers, lenders, or third parties such as regulators and/or service providers, may negotiate and transact with said PFIs and/or LPFIs. In step 4, said PFIs may preferably perform market analysis, risk management, and/or record-keeping functions and/or communicate transactional and/or other information to other agents or facilities. Transactions may result in changes to the internal state of one or more said PFIs or to changes in the ownership and/or custody arrangements of one or more PFIs and/or DFIs. Other web agents (and preferably virtual and/or physical devices) representing and/or embodying actual or potential borrowers, lenders, or third parties such as regulators and/or service providers, may negotiate and transact with said PFIs and/or PPFIs.

In an alternative preferred embodiment, PFIs may be physical devices subject to influence by an active software/system component or module and the physical environment. Said PFIs may link up with other PFIs to create one or more lending pools of PFIs (“LPFI”). Said PFIs and/or LPFIs may negotiate with other web agents (and preferably physical devices) to form one or more new PFIs securitized by said PFIs and/or LPFIs. Other web agents (and preferably physical devices) representing actual or potential borrowers, lenders, or third parties such as regulators and/or service providers, may negotiate and transact with said PFIs and/or LPFIs.

[Note: Both of the above-described preferred embodiments create PFIs that may assemble themselves into portfolios on behalf of their owners, fiduciaries, or agents thereof, allowing the PFIs to help manage portfolios, lend securities, recall securities that have been loaned, analyze markets, manage risk, keep record subject to constraints imposed by the program, other agents, and the environment. The inclusion of physical devices allows human traders, analysts, risk managers, portfolio managers, and others to enter and interact in this environment with human and computer counterparts all over the world—both in physical and virtual space.]

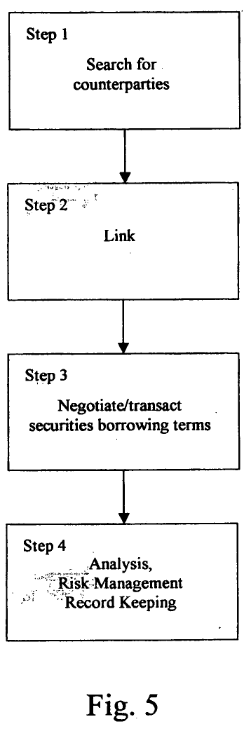

A preferred embodiment for operation and use of the invention for auto-securities borrowing is now described in connection with FIG. 5.

As shown in FIG. 5, step 1, PFIs which may preferably be programmable internet/web agents (preferably linked to physical devices) scour one or more computer networks (and preferably other virtual environments and/or physical environments) for counterparties. In step 2, said PFIs may link up with other PFIs to create one or more borrowing pools of PFIs (“BPFI”). In step 3, said PFIs and/or BPFIs may negotiate with other web agents (and preferably virtual and/or physical devices) to form one or more new PFIs, BPFIs, and/or DFIs securitized by said PFIs and/or BPFIs. Other web agents (and preferably physical devices) representing actual or potential borrowers, lenders, or third parties such as regulators and/or service providers, may negotiate and transact with said PFIs and/or BPFIs. In step 4, said PFIs may preferably perform market analysis, risk management, and/or record-keeping functions and/or communicate transactional and/or other information to other agents or facilities. Transactions may result in changes to the internal state of one or more said PFIs or to changes in the ownership and/or custody arrangements of one or more PFIs and/or DFIs. Other web agents (and preferably virtual and/or physical devices) representing and/or embodying actual or potential borrowers, lenders, or third parties such as regulators and/or service providers, may negotiate and transact with said PFIs and/or PPFIs.

In an alternative preferred embodiment, PFIs may be physical devices subject to influence by an active software/system component or module and the physical environment. Said PFIs may link up with other PFIs to create one or more borrowing pools of PFIs (“BPFI”). Said PFIs and/or BPFIs may negotiate with other web agents (and preferably physical devices) to form one or more new PFIs securitized by said PFIs and/or BPFIs. Other web agents (and preferably physical devices) representing actual or potential borrowers, lenders, or third parties such as regulators and/or service providers, may negotiate and transact with said PFIs and/or BPFIs.

[Note: Both of the above-described preferred embodiments create PFIs that may assemble themselves into portfolios on behalf of their owners, fiduciaries, or agents thereof, allowing the PFIs to help manage portfolios, borrow securities, return securities to a lender, analyze markets, manage risk, keep records—subject to constraints imposed by the program, other agents, and the environment. The inclusion of physical devices allows human traders, analysts, risk managers, portfolio managers, and others to enter and interact in this environment with human and computer counterparts all over the world—both in physical and virtual space.]

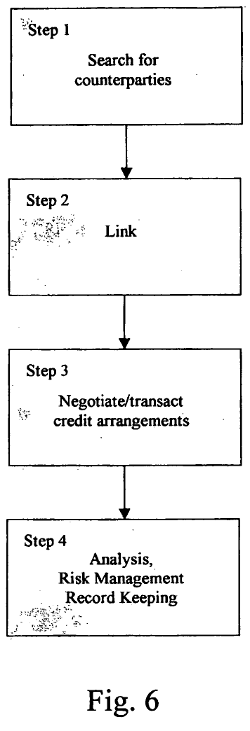

A preferred embodiment for operation and use of the invention for auto-credit-enhancement is now described in connection with FIG. 6.

As shown in FIG. 6, step 1, PFIs which may preferably be programmable internet/web agents (preferably linked to physical devices) scour one or more computer networks (and preferably other virtual environments and/or physical environments) for counterparties. In step 2, said PFIs may link up with other PFIs to create one or more credit enhancement PFIs (“CPFI”). In step 3, said PFIs and/or CPFIs may negotiate with other web agents (and preferably virtual and/or physical devices) to form one or more new PFIs, CPFIs, and/or DFIs securitized by said PFIs and/or CPFIs. Other web agents (and preferably physical devices) representing actual or potential borrowers, lenders, or third parties such as regulators and/or service providers, may negotiate and transact with said PFIs and/or CPFIs. Said PFIs and/or CPFIs may facilitate credit enhancement by establishing escrow accounts for borrowers. Said escrow accounts may hold a portion of the nominal interest charged to the borrower. Said interest may be credited back to the borrower according to a set of rules which may be coded into the PFI. In a preferred embodiment, the PFI could extend a single interest rate to all borrowers, with different amounts (preferably reflecting a borrower's credit rating) held in escrow and preferably eligible for crediting back to the borrower. Said escrow accounts may be coded into one or more PFIs, and may be invested according to rules coded into one or more PFIs. In step 4, said PFIs may preferably perform market analysis, risk management, and/or record-keeping functions and/or communicate transactional and/or other information to other agents or facilities. Transactions may result in changes to the internal state of one or more said PFIs or to changes in the ownership and/or custody arrangements of one or more PFIs and/or DFIs. Other web agents (and preferably virtual and/or physical devices) representing and/or embodying actual or potential borrowers, lenders, or third parties such as regulators and/or service providers, may negotiate and transact with said PFIs and/or CPFIs.

In an alternative preferred embodiment, PFIs may be physical devices subject to influence by an active software/system component or module and the physical environment. Said PFIs may link up with other PFIs to create one or more credit enhancement PFIs (“CPFI”). Said PFIs and/or CPFIs may negotiate with other web agents (and preferably physical devices) to form one or more new PFIs securitized by said PFIs and/or CPFIs. Other web agents (and preferably physical devices) representing actual or potential borrowers, lenders, or third parties such as regulators and/or service providers, may negotiate and transact with said PFIs and/or CPFIs. Said PFIs and/or CPFIs may facilitate credit enhancement by establishing escrow accounts for credit impaired borrowers. Said escrow accounts may hold a portion of the nominal interest charged to the borrower. Said interest may be credited back to the borrower according to a set of rules which may be coded into the PFI. In a preferred embodiment, the PFI could extend a single interest rate to all borrowers, with different amounts held in escrow and eligible for crediting back to the borrower. Said escrow accounts may be coded into one or more PFIs, and may be invested according to rules coded into one or more PFIs.

[Note: Both of the above-described preferred embodiments create PFIs that may assemble themselves into portfolios on behalf of their owners, fiduciaries, or agents thereof, allowing the PFIs to help manage credit portfolios, trade, establish escrow accounts, perform credit analysis, analyze markets, manage risk, keep records—subject to constraints imposed by the program other agents, and the environment. The inclusion of physical devices allows human traders, credit analysts, risk managers, portfolio managers, and others to enter and interact in this environment with human and computer counterparts all over the world—both in physical and virtual space.]

Wherein I claim:

1. A method for creating and using programmable financial instruments, said method comprising:
selecting a program;
defining one or more financial instruments, the financial instruments having a plurality of characteristics, the step of defining comprising:
selecting a type for each financial instrument, said type subject to modification by the program;
selecting a set of terms and conditions for each financial instrument, the terms and conditions subject to modification by the program.

2. The method of claim 1, where said financial instrument's program modifies its state in response to its environment.

3. The method of claim 2, where said program seeks out counterparties for financial transactions.

4. The method of claim 3, where said counterparties comprise internet/web agents.

5. The method of claim 3, where said counterparties comprise virtual devices.

6. The method of claim 3, where said counterparties comprise physical devices.

7. The method of claim 3, where said transactions involve borrowing one or more financial instruments.

8. The method of claim 3, where said transactions involve lending one or more financial instruments.

9. The method of claim 3, where said transactions involve securitization of one or more financial instruments.

10. The method of claim 9, where said securitization includes the creation of tranches of securities.

11. The method of claim 1, where the financial instrument interacts with one or more financial trading systems external to said instrument.

12. The method of claim 11, where one or more of said financial trading systems is used for simulation of trading strategies.

13. The method of claim 12, where said simulation takes place in real time.

14. The method of claim 11, where one or more of said financial trading systems is used for optimization of trading strategies.

15. The method of claim 14, where said optimization takes place in real time.

16. The method of claim 11, where one or more of said financial trading systems is used for risk management.

17. The method of claim 16, where said risk management takes place in real time.

18. The method of claim 1, where said financial instrument acts as a credit manager.

19. The method of claim 18, where said credit manager establishes one or more escrow accounts for one or more borrowers.

20. The method of claim 19, where said escrow accounts are allocated a programmatically determined portion of said borrowers' payments to said credit manager.

21. The method of claim 20, where said escrow accounts are used to establish a uniform rate of interest for all borrowers.

22. The method of claim 19, where said credit manager actively manages the funds in said escrow accounts.

23. The method of claim 1, where said program is an internet/web agent.

24. The method of claim 1, wherein said method is facilitated by one or more computers.

25. A system for creating programmable financial instruments, said system comprising:
a means for selecting a program;
a means for defining one or more financial instruments, said financial instruments having a plurality of characteristics, said definition comprising:
means for selecting a type for the financial instruments, said type subject to modification by the program;
means for selecting a set of terms and conditions for the financial instruments, said terms and conditions subject to modification by said program.
